(19) United States
(12) Patent Application Publication
(10) Pub. No.: US 2003/0035430 A1
(43) Pub. Date: Feb. 20, 2003

(54) Programmable network device

(76) Inventors: Junaid Islam, San Jose, CA (US); Homayoun Valizadeh, Danville, CA (US); Jeffrey S. Payne, Seattle, WA (US)

Correspondence Address: Shailesh Mehra, Suite 200, 4695 Chabot Drive, Pleasanton, CA, 94588, US

(21) Appl. No.: 09/918,363

(22) Filed: Jul. 30, 2001

Related U.S. Application Data
(63) Continuation-in-part of application No. 09/679,321, filed on Oct. 3, 2000.

(51) Int. Cl. H04L 12/28

(52) U.S. Cl. 370/401; 709/223

(57) ABSTRACT

A programmable network device is described. The programmable network device executes software modules resident on its hardware to support assorted applications and network management services. These modules may be dynamically loaded, unloaded, or modified without interrupting network traffic routed through the device. The loading and unloading of modules can be administered remotely, via a network backbone, service provider network, LAN, or other internetwork coupled to the device. Alternatively, administrators may alter the operating parameters of individual management modules via the network to effect performance gains or modify existing operating parameters.

This application claims priority to U.S. application Ser. No. 09/679,321, entitled “Programmable Network Application Server,” filed Oct. 3, 2000, inventors Junaid Islam, Jeffery S. Payne, Homayoun Valizadeh, which is hereby incorporated by reference in its entirety

### FIELD OF THE INVENTION

The invention is a networking device. More specifically, the invention comprises a programmable networking device used to perform a variety of networking applications while maintaining a specified throughput.

### DESCRIPTION OF RELATED ART

The Inadequacies of Pre-Programmed Network Devices

Existing network environments are characterized by a disjunction between programmable components, which are generally CPUs in workstations connected to the network, and pre-programmed units in the infrastructure of the network, such as routers and switches. By design, these pre-programmed network devices are closed from the perspective of network users and service providers.

The rigidity of pre-programmed network devices results in inefficiencies in the maintenance of networks and inflexibility in the deployment of new services or enhancement of existing services. For instance, the provisioning of new applications at a node in a network typically entails the overhead of one or more of the following: 1) developing hardware to support the new applications 2) writing new software for existing network platforms to support the desired applications 3) deploying workforce to the network node to install hardware and/or software developed to support the desired applications 4) interrupting or re-routing traffic that would otherwise pass through the device while the device is upgraded with the new hardware and/or software.

The prior art does include some network devices in which parameters may be changed via a network, without requiring the network device to be restarted or interrupting traffic through the device. One such example is IOS from Cisco®. Such systems, however, only allow parameters to be adjusted without restarting the device. They do not allow for the addition or deletion of software modules without interruption to network services.

As a result of this inflexibility, network service providers are constrained in the geographical breadth of their services by physical resources. As personnel must be dispatched to install and administer existing network devices, service providers are constrained to offer services only where they have sufficient manpower and physical resources. Consequently, there are currently no network service providers with global reach.

The Coupling of Hardware and Software in Existing Network Devices

The pre-programmed nature of existing network devices also results in a tight coupling between hardware and software used on the network devices. In the vast majority of network devices, new application modules may not be added dynamically, as such devices typically utilize a single, monolithic program which executes a finite set of services. Though routers have been developed for platforms such as Windows NT®, such technologies are too slow for widespread use in service provider networks and do not allow for the dynamic loading and unloading of applications without interrupting packet forwarding. As such, to provide new services, service providers are often forced to replace existing network devices with new devices that include software for the respective service, a process that may take years. The replacement of boxes to support new functions has grown particularly problematic, as the amortization period of network devices continues to shrink. As such, the coupling of hardware and software places an onerous financial constraint on service providers.

Moreover, the coupling of hardware and software on network devices precludes third parties from developing applications for the devices. Given existing network technology, third parties wishing to develop new applications for the devices would have to co-operate with the device manufacturers to have their software included in the device prior to deployment. Existing network devices make no provisions for the inclusion of new modules after deployment. As the development of new services accelerates, network devices become obsolete before generating an adequate return on investment.

Inability to Place Agents on Existing Network Devices

The inability to load modules, or agents, on existing network devices presents difficulties in the analysis of network parameters. Existing network devices do not allow agents to be uploaded in order to analyze or act upon network traffic. An example of this inefficiency is evident in existing support of Service Level Agreements (SLAs). Existing SLA techniques typically utilize SNMP or an another architecture which polls network devices periodically to read counters. Such data is collected and then transported over the network for post-facto analysis, i.e., to determine packet discard rate and other relevant parameters. This architecture demands substantial overhead to scale to a large number of devices and does not offer traffic analysis in true real-time.

The inadequacies of current network devices evince a need for reprogrammable devices that support multiple network management functions. Code supporting network management functions should be dynamically loadable on network devices, thereby alleviating the need install new devices at network nodes. Devices should also be remotely configurable in order to eliminate the costs of deploying manpower to service the devices. Such devices should also be scalable to accommodate network expansion, and should facilitate load balancing and redundancy.

### SUMMARY OF THE INVENTION

The present invention includes systems and methods for supporting a programmable network device. The programmable network device is capable of executing software modules resident on its hardware to support assorted applications and network management services. These modules may be dynamically loaded, unloaded, or modified without interrupting network traffic routed through the device; without interrupting or otherwise affecting other modules executing at the time; and without requiring the device to be restarted or rebooted. Modules may be loaded, unloaded, or modified either locally, or remotely via any type of network in communication with the device. Alternatively, administrators may alter the operating parameters of individual management modules via the network to effect performance gains or modify existing operating parameters.

In some embodiments, the device may reside at any point within a network or between two or more networks. In embodiments of the invention, the programmable network device may reside at the edge of a Wide Area Network (WAN) and fan out to one or more Local Area Networks (LANs). The WAN may be an Autonomous System, a Service Provider Network, or other type of internetwork. In some such embodiments, the WAN may be administered by a Service Provider, while the one or more LANs are situated at customer premises. In other embodiments, the programmable network device may be located at a customer site and connect to a service provider network via the customer's Local Area Network. In some such embodiments, the programmable network device may tunnel to the service provider network via a Virtual Private Network, or VPN.

The invention enables administrators to load, unload, or alter modules on the programmable network devices remotely, via one or more networks in communication with the device. These modules may emulate legacy systems, provide VPN services such as tunneling protocols, support network management functions, or provide new types of applications developed by network service providers or third party developers. By enabling the remote uploading of new modules, the invention helps to eliminate the lag time in the provision of new network services. Likewise, by enabling remote administration of the programmable network device, the invention pre-empts the necessity of allocating personnel to maintain the devices.

By decoupling hardware and software on programmable network devices, the invention allows hardware and software components to be retailed to subscribers separately. This feature of the invention also allows third party development of networking applications.

Embodiments of the invention employ a multi-tiered software architecture comprising a forwarding engine, an application tier, and a network management tier. In embodiments, the forwarding tier is responsible for forwarding packets between networks coupled to the programmable network device. In embodiments, the forwarding engine also includes encryption and authentication mechanisms for accessing modules in the programmable network device. The forwarding engine is also a conduit between modules resident on the programmable network device and data packets traversing the programmable network device.

The application tier contains modules for networking applications. Such applications may correspond to VPN functions, including but not limited to applications such as Multiprotocol Label Switching, or MPLS, Layer Two Tunneling Protocol, or L2TP, and IP Sec. This allows the programmable network device to emulate any type of VPN. The modules may also be unrelated to VPNs, and support applications such as Traffic Shaping or Multicasting. Modules in the application tier may also be encoded to support entirely new types of applications.

Another tier in the software architecture comprises a network management layer. Modules in this tier may support remote network monitoring and management protocols, such as the Simple Network Management Protocol (SNMP) and the Common Management Information Protocol (CMIP). Modules may include support for CORBA Object Request Broker or an XML based messaging protocol handler. The network management tier may also include modules facilitating the monitoring and enforcement of service level maintenance functions in support of Service Level Agreements (SLAs).

In embodiments of the invention, the programmable network device is implemented by use of a hardware configuration which may include one or more of the following: one or more processors dedicated to the forwarding engine, one or more processors dedicated to the applications and network management tiers, an data ports which, by way of non-limiting example, may be any one or more of an Ethernet port, an Asynchronous Transfer Mode (ATM) port, a SONET/SDH port. Modules on the programmable network device are executed on the general execution processors. In some embodiments of the invention, the forwarding engine may be encoded in microcode. The separation between the processors supporting the forwarding engine and the application processors allow packets to be streamed through the forwarding engine continuously, irrespective of loading, unloading, modification, or failure of one or more modules running on the general execution processors.

In embodiments of the invention, the programmable network device may be configured to operate in parallel with similar devices. For instance, a cluster of programmable network devices may be stacked, in order to facilitate distributed processing and redundancy. In embodiments of the invention, stacked servers may be coupled by a local network or via a WAN, such as a service provider network or the Internet. In embodiments of the invention, the devices may be stacked, or coupled, by daisy chaining; in other embodiments, the devices may be coupled via a hub configuration. In embodiments of the invention, the modules are executed as threads distributed over multiple programmable network devices. These and other aspects and embodiments of the invention shall be elaborated herein.

### DESCRIPTION OF FIGURES

FIG. 1 illustrates a location of a programmable network device between a Local Area Network and a Wide Area Network according to embodiments of the invention.

FIG. 2 illustrates a multi-tiered software architecture of the programmable network device.

FIG. 3 illustrates line cards used in embodiments of the programmable network device.

FIG. 4 illustrates a stacked configuration of multiple programmable network devices.

FIG. 5 illustrates a model of software organization within processors in the programmable network device.

FIG. 6 illustrates a packet format for a Multi CPU Communication Protocol used internally by embodiments of the programmable network device.

FIG. 7 illustrates components of the programmable network device used to add and delete flows in embodiments of the invention.

FIG. 8 illustrates a method of adding a flow to the programmable device according to embodiments of the invention.

### DETAILED DESCRIPTION

A. Overview of the Programmable Network Device

Some embodiments of the invention include a Programmable Network Device, which may be located at any point within a network or between networks. In some embodiments, the device may be located at customer, or enterprise premises; in other embodiments, the device may be located at an edge of a service provider network. In some embodiments, the Programmable Network Device may be owned and/or operated by a Service Provider (SP) or carrier connecting the customer, or enterprise, to a Wide Area Network (WAN). The WAN may be an Autonomous System, service provider backbone, or other type of internetwork. Alternatively, the device may be owned/and or operated by the enterprise itself.

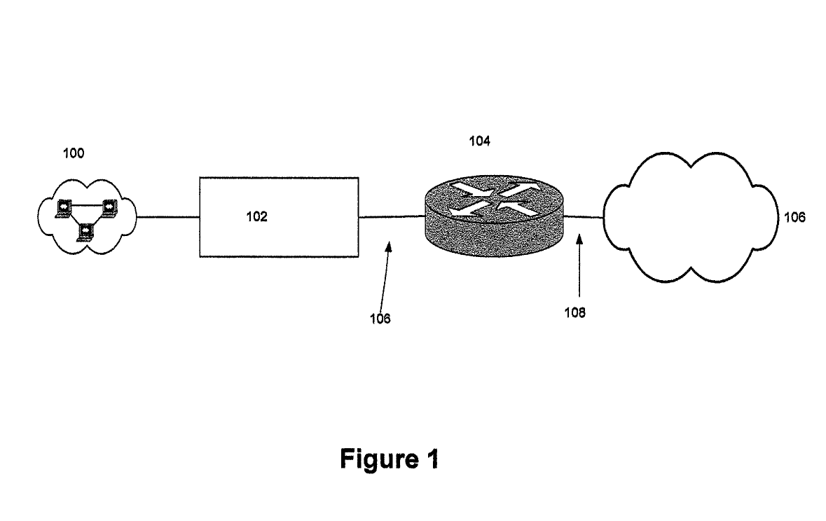

In embodiments of the invention illustrated schematically in FIG. 1, the Programmable Network Device 102 may be a self-contained unit which resides behind an access router 104 and supports IP services to the enterprise 100. In alternative embodiments, the Programmable Network Device may be instantiated as an access router.

In embodiments of the invention, the Programmable Network Device may include two or more physical interfaces 106 108 for carrying data; in embodiments, these interfaces may operate at rates of 1 Gbps or higher. In some such embodiments, the physical interfaces 106 108 may comprise Gigabit Ethernet interfaces; in other embodiments, one or more of the physical interfaces may comprise 10/100 Ethernet interfaces. One of these interfaces 106 may connect to the access router 104, and the other 108 to the enterprise network 100. In embodiments of the invention, the device 102 may include additional interfaces for management, which may include, but are not limited to a console or modem to a serial port, or a 10/100 Ethernet port.

B. Multi-Tiered Logical Architecture

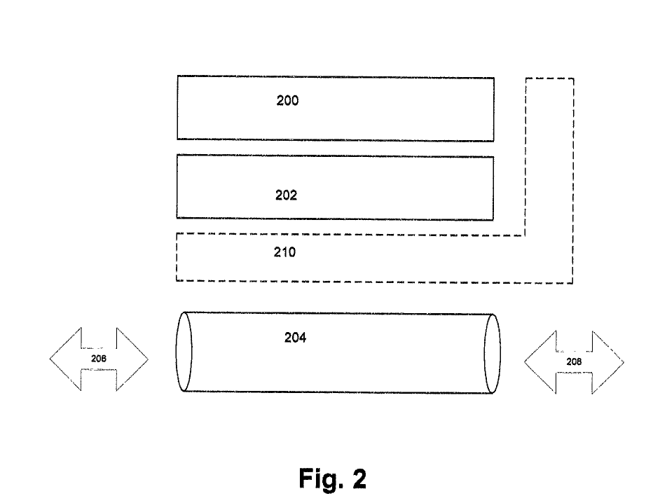

FIG. 2 illustrates a logical architecture of the Programmable Network Device. Multiple logical layers 200 202 204 210 are depicted. At the lowest level is a hardware instantiated data-forwarding layer 204. This layer provides hardware acceleration for forwarding data specified line rates. In embodiments of the invention, the hardware data forwarding layer 204 supports line rates of a gigabit or higher. The hardware layer 204 continues to forward data in case of software failures. That is, if one or more software modules operating on the programmable network device fail, the hardware layer 204 may continue forwarding data in order to preserve connectivity between networks coupled to the Programmable Network Device.

Embodiments depicted in FIG. 2 also include a core application layer 202. This layer may include numerous types of applications such as, by way of non-limiting example, Virtual Private Network (VPN) applications, Network Address Translation (NAT), IPSEC applications, firewall applications, etc. Software modules may be loaded onto the programmable network device 102 either prior to deployment or via the service provider network 100 at any time in its operation. Software modules may be loaded or unloaded from the programmable network device 100 during its operation, without disrupting packet forwarding through the programmable network device. It is desirable for such applications to be very stable, to recover from failure without customer intervention, and to perform in accordance with any Service Level Agreements (SLAs) in effect. In some embodiments of the invention, core applications may be assigned higher priority than other applications in order to ensure the applications adequate time and resources to achieve defined performance objectives.

FIG. 2 also includes a management layer 200 comprised of management applications. In embodiments of the invention, these management applications employ Application Programming Interfaces (APIs) exposed by core applications 202 and the system infrastructure. By way of non-limiting example, management applications may sample the system statistics periodically in order to ensure that any SLAs in effect are satisfied. In some embodiments of the invention, these management applications are granted a specified number of CPU cycles. In embodiments, the management applications employ the open APIs provided by the system and the core applications.

An infrastructure layer 210 includes tools which may be used by all applications in the programmable network device, which may include, but are not limited to, any one or more of the following: an operating system for the application; APIs to the forwarding engine, hardware offsets for security, hardware offsets for compression, hardware for packet reassembly;

C. Hardware Architectures of the Programmable Network Device

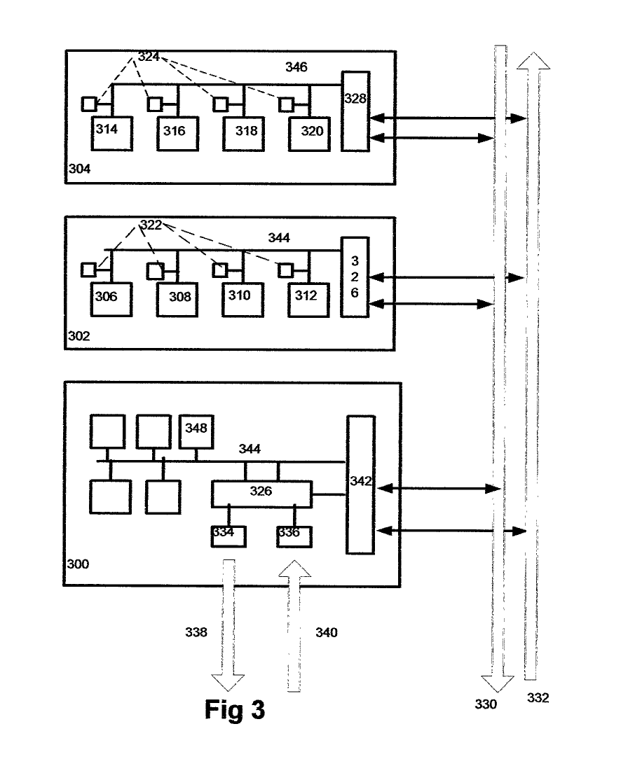

A hardware architecture used by embodiments of the invention to implement the logical view of the architecture is illustrated in FIG. 3. In embodiments of the invention, the programmable network device unit includes one or more Application Processor Cards, (APC's) farm card 302 304, each APC including multiple CPUs 306-320. In embodiments, these CPUs 306-320 may be general purpose CPUs, such as processors from the Intel Pentium® family, the Power PC® series, or those offered by Transmeta® Inc; alternative CPUs will be apparent to those skilled in the art. Core and management applications are executed on the CPUs 306-320 resident on the Application Processor Cards 302 304.

In embodiments of the invention, the Application Processor Card may include one or more encryption processors 322 324 to perform encryption services for the CPUs 306-320. These encryption services may include, but are not limited to Diffie-Hellman operations, RSA signatures, RSA verifications, etc. In embodiments, each CPU 306-320 in the Application Processor Cards 302 304 has its own encryption processor 322 324. Examples of commercial encryption processors that may be utilized include the HiFn 6500 and the Broadcom BCM 5820. Alternative security processors will be apparent to those skilled in the art.

In embodiments, each of the Application Processor Cards 302 304 also includes a switch 326 328 342 allowing the processors 306-320 to communicate with a backplane 330 332 of the device. In embodiments, the backplane may include two or more unidirectional buses, including an uplink 332 and a downlink 330. The uplink and downlink each transmit data at rates of 10 Gbps or higher. In embodiments, the uplink and downlink operate by use of Low Voltage Differential Signaling, or LVDS. In embodiments of the invention, the switches 326 328 342 may comprise customized ASICs; in other embodiments, the switches may be implemented on FPGAs. Examples of FPGAs that may be used for the switch include those produced by Xilinx®, Inc. Alternative FPGAs will be apparent to those skilled in the art.

In embodiments of the invention, the forwarding engine 204 is implemented in a Network Processor Card (NPC) 300, also depicted in FIG. 3. The Network Processor Card 300 may include one or more network processors to perform functions on inbound and outbound packet flows. In embodiments as illustrated in FIG. 3, the Network Processor Card may have two sets of network processors 334 336 which handle outbound 338 and inbound 340 traffic respectively. In particular, an inbound PHY interface 340 and an outbound PHY interface 338 may both interact with Gigabit Ethernet ports. Examples of suitable Network Processors 334 336 include the Intel® IXP Chip, the Agere family of Network Processors, and Motorola Inc.'s C-Port network processor; other suitable network processors will be apparent to those skilled in the art. Alternatively, a special purpose ASIC may be used to support functions on traffic flows.

The Network Processor Card 300 may also contain one or more controller CPUs referred to as controller CPUs 326 for controlling and managing the network processors 334 336. The controller CPUs may also be general purpose CPUs.

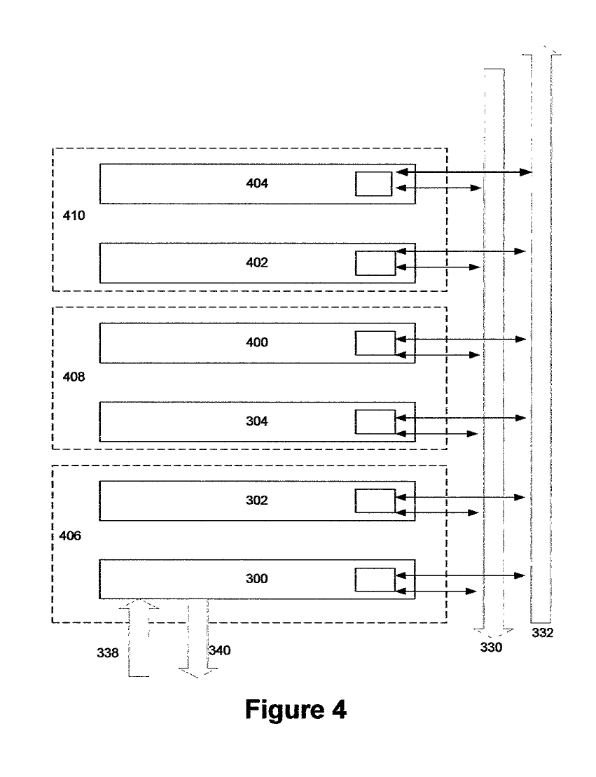

FIG. 4 illustrates a configuration by which multiple programmable network devices 406 408 410 may be stacked via the high speed bus 330 332. In embodiments, a first programmable network device 406 includes a Network Processor Card 300 and an Application Processor Card 302 in a first chassis. In embodiments, the chassis is designed for inclusion in a standard carrier rack which is NEPS compliant. The first programmable network device 406 may be coupled via the bus to one or more programmable network devices 408 410. In embodiments, each of the programmable network devices 408 410 includes two or more Application Processor Cards 304 400 402. In other embodiments, for redundancy purposes, one of the programmable network devices may contain a standby Network Processor Card, which may be activated if the main Network Processor Card 300 fails.

FIG. 3 also depicts an internal communications bus comprised by internal buses 348 344 346 in the Processor Cards 302 304 306, the stacking logic between the Processor Cards 300 302 304 and the bus 330 332. In embodiments of the invention, the local buses 344 346 348 within the Processor Cards 302 304 306 may be PCI buses; alternative implementations of the local buses will be apparent to those skilled in the art.

Hardware Acceleration in the Forwarding Engine

In embodiments, the programmable network device may include one or more sets of dedicated processors 334 336 for packet forwarding; these sets may include, by way of non-limiting example general purpose CPUs, customized ASICs, or network processors. API calls to these processors 334 336 may include, by way of non-limiting example, calls that set filters, add and remove tree elements, etc. In embodiments of the invention, such software resides on the Controller CPU 326. In such embodiments, the API is extended to applications on other CPUs 306-322 by use of a Multi-CPU Communication Protocol, described elsewhere in this specification. In embodiments, the API may also be used to read statistics from the Network Processors 334 336.

In embodiments of the invention, each of the network processors 334 336 comprises a set of micro-coded engines. In embodiments, the micro-code for these processors is stored in a local file system, and is downloaded from a remote server. In embodiments, the remote server is coupled to the programmable network device via an internetwork. In some embodiments, the micro-code determines which applications are executed on the programmable network device, as well the sequence in which they are run. The micro-code may also provide hooks whereby new applications can filter out packets and re-insert them into the data stream.

In embodiments of the invention, encryption/decryption/key generation engines 322 324 are attached one or more of the application CPU s 306-322. A driver for these engines makes these functions available in user and kernel space.

In embodiments, a compression/decompression engine is attached to one or more of the application CPUs 306-322. In some such embodiments, the driver for these engines makes these functions available in user and kernel space

Embodiments of the programmable network device include a file system contained in a micro-drive 348 in the Network Processor Card 300. In embodiments of the invention, the file system may based on a Unix/Linux file; in other embodiments, the file system may be based on a DOS/Windows File Allocation Table. Alternative file systems will be apparent to those skilled in the art. In embodiments supporting Linux, the file system may include configuration files, application and OS binaries, shared libraries, etc.

In embodiments of the invention, the file system is directly attached to the Controller CPU 326 In embodiments of the invention, the Controller CPU 326 exports the file system to the application CPUs 306-322, which may mount the file system as part of diskless operation.

D. Software Services Supported within the Programmable Network Device

In embodiments of the invention, once the controller CPU 326 and other CPUs 306-322 are loaded with operating systems, a number of manager/server applications are started. They may be started on any CPU 306-322 in the system. Non-limiting examples of the standard services may include file servers, telnet servers, console I/O, etc. Other services may include one or more of the following:

Name Registry

In embodiments of the invention, every application program in the programmable network server offering a service registers with the Name Server. The Name Registry maintains information which may include the application's name, version, and a local address where it can be reached by other applications. The Name Registry itself is available at a well-known address, and runs on the Controller CPU after it boots up.

Programmable Network Device Manager and CPU Manager.

Embodiments of the invention include a Programmable Network Device Manager (PND Manager) which is used to start all applications other than those that are part of the infrastructure. The PND Manager, which may run on the Controller CPU 326, reads the configuration information, and starts applications on various CPUs. In embodiments, the PND performs this function in conjunction with a CPU Manager, which has instances running on the other CPUs 306-322. In some embodiments of the invention, the CPU Manager runs in every application CPU 306-322. In embodiments of the invention, the PND Manager balances load based on the loading of CPUs as measured by the CPU Manager; alternatively, the PND Manager may select a fixed CPU for an application based on its configuration. When an application is started up, the CPU Manager allocates CPU resources for a given application, such as, by way of non-limiting example, the application's priority or real-time quota. In embodiments of the invention, the CPU manager starts up in a CPU as soon as it boots up, and has a well-known address.

Statistics Manager.

In embodiments of the invention, applications periodically make their statistics available to a statistics manager. The statistics manager may run on any CPU in the Programmable Network Device. The Statistics Manager can be queried by management applications through an API. In embodiments of the invention, the Statistics Manager registers with the Name Registry, so applications will be able to locate it by querying the Name Registry.

E. Software Organization within CPUs

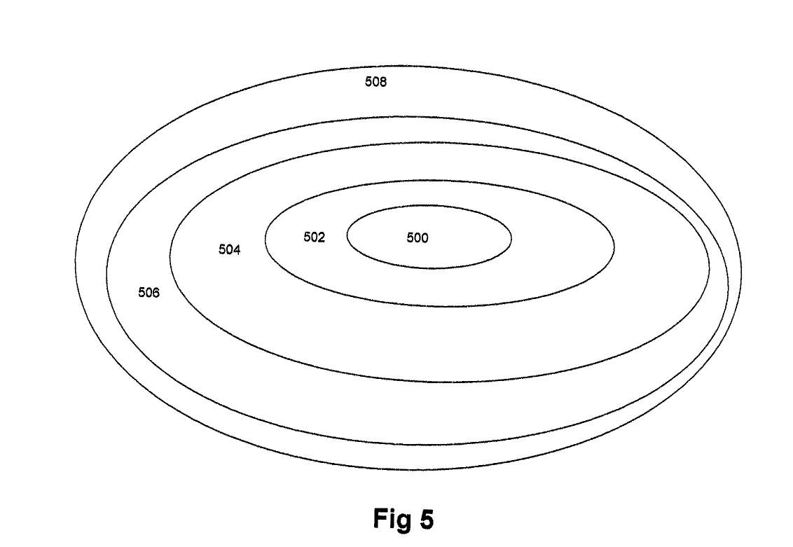

In embodiments of the invention, all of the CPUs 306-322 include identical operating system kernels. The software architecture of individual CPUs is illustrated in FIG. 5. The CPUs 300-322 in the CPU cards 330-334 run core 504 and network management 508 applications. Non-limiting examples of core applications may include Firewall, Network Address Translation (NAT), IPSEC/VPN, Layer 2 Tunneling Protocol (L2TP), Routing, Quality of Service (QoS), Multi Protocol Label Switching (MPLS), IP Multicast; other examples of core applications will be apparent to those skilled in the art. In embodiments of the invention, core applications 504 are allocated sizeable ratios of CPU resources for meeting performance goals, while management applications 508 are allocated a smaller, pre-defined percentage of a CPU. In some such embodiments, this pre-defined percentage may be on or about 5% of CPU resources. All of the management applications 408 will share this allocation. If core applications 504 do not use the CPU resources allocated to them, these CPU resources will be available for management applications 508.

In embodiments of the invention, all of the applications are loaded dynamically, and into their own memory protected segments. While core applications 504 may have driver components loaded into the kernel 500, in embodiments of the invention, management applications 508 do not have driver components

In embodiments of the invention, the Controller CPU 326 controls the startup of all of the sub-systems in the programmable network device. In some embodiments of the invention, this CPU 326 includes a flash memory unit and a hard disk micro-drive which store the operating system and application binaries for all of the CPUs 300-322, along with any configuration information. In embodiments of the invention, the Controller CPU 326 also includes a serial port for attachment of a console, modem, and/or an Ethernet port—such as a a 10/100 Mbit/s Ethernet port—for management. The Controller CPU 326 may also support telnet/console sessions. In embodiments of the invention, the application CPUs 300-322 mount their file systems from the Controller CPU 326, and will see the same files as any application running on the Controller CPU 326.

Dynamic Loading and Unloading of Drivers and Applications

In the environment of the programmable network device, applications may be started and stopped frequently as the carrier, ISP, or enterprise can deploy services dynamically. Embodiments of the invention include a secure protocol between the programmable network device and a separate server for loading applications and configuration information. Also, when an application exits, the OS and system applications may perform cleanup. In those embodiments of the programmable network device employing Linux, the Linux operating system provides the basic mechanisms for loading and unloading applications and drivers in a CPU. Every application has its own virtual address space in the Linux environment, so they will not corrupt other applications.

The mechanisms for remotely loading applications from a server are also standard. In embodiments of the invention, a secure version of FTP may be used to download applications and configuration files from servers into flash memory. Administration may be performed through a secure connection such as Secure CRT. Through this secure connection, applications and drivers can be loaded and unloaded dynamically. In embodiments of the invention, prior to loading an application or driver, the application or driver is downloaded into flash memory.

F. Multi-CPU Communication Protocol

Embodiments of the invention include a Multi-CPU Communication Protocol, or MCCP, comprising a link level protocol for communication between processors in the Programmable Network Device. In embodiments of the invention, MCCP is a connectionless service. MCCP addresses identify a CPU in a stacking hieracrchy of the programmable network device. Above the link level, the MCCP may carry multiple protocols. In embodiments of the invention, the MCCP protocol header identifies the actual protocol, which may be, for example, UDP or TCP. For the purposes of MCCP, the network processors 334 336 are treated as special CPUs.

In embodiments of the invention, all communications between CPUs in the programmable network device utilize MCCP. As part of initialization, every CPU discovers its address and location in a programmable network device hierarchy, including CPUs that are part of stacked modules. In some such embodiments, each CPU in the programmable network device obtains a unique MCCP address for itself. In embodiments of the invention, the MCCP address serves as the equivalent of a physical address in the stacking bus

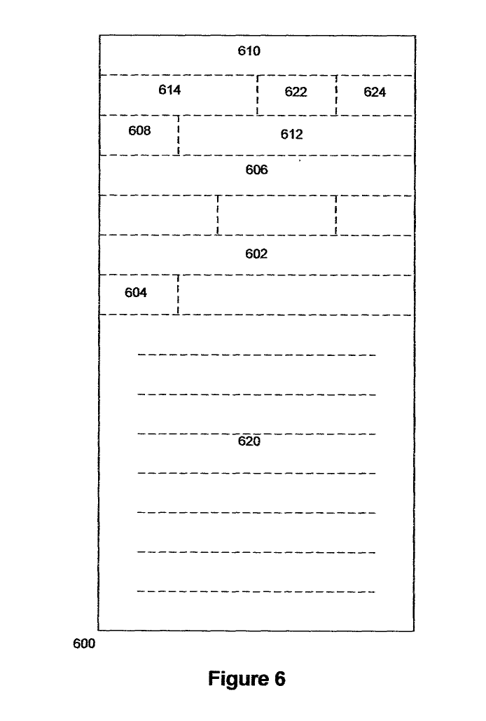

Embodiments of the Multi CPU Communication Protocol, or MCCP, include packets with a format as illustrated in FIG. 6. The packets may originate from any of the CPUs, including the application CPUs 306-322, the Controller CPU 326, or one or the Network Processors 334 336.

Embodiments of the protocol include a protocol header 600 as illustrated in FIG. 6. The header may include one or more fields indicating a Source Slot Number 602. In embodiments of the invention, the Source Slot Number 602 may refer to a particular processor card in a stack of programmable network devices. In some embodiments, the header may include a Source CPU Number 604, which indicates an identification number for a source CPU within the particular processor card. The Source CPU Number 604 indicates the CPU which originates the MCCP packet.

Embodiments of the invention include a Destination Box number 606; in some embodiments, this field indicates an identifier for a processor card in a stack of programmable network devices. This processor card contains the CPU which is the intended destination for the MCCP packet. A Destination CPU Field 608 identifies a CPU within the processor line card to which the MCCP packet is directed.

In embodiments of the invention, the MCCP packet may also include one or more of the following fields:

A Start of Packet field 610 indicating the start of an MCCP Packet 600. In embodiments, this is a constant field, which may be a palindrome such as 5A₁₆

One or more fields indicating packet length 612 614. In embodiments, one field may indicate least significant bits 614 and another may indicate most significant bits 612

In embodiments, an MCCP packet 600 may include several bytes for payload 620

A DMA field 622, which indicates a DMA that may be used to send the MCCP packet 600 to the destination CPU. In embodiments, the DMA field 622 is used by the backplane switch 326 328 342—which may be an FPGA or ASIC—to determine which of several DMAs to use.

A Stacked Bus Packet Identifier field (SPI) 624 for indicating a type of packet. For instance, in embodiments, values of the SPI 624 may indicate that the MCCP packet 600 is one of the following:

A Box Numbering used at startup to inform a particular processor of its number within the respective line card

A CPU reset used to reset a CPU

An unCPU reset

G. Networking Infrastructure within the Programmable Network Device

In some embodiments of the invention, the application CPUs 306-320, the Controller CPU 326, and the Network Processors 334 336 are treated as separate network nodes with individual unique addresses; in some embodiments, these unique addresses may comprise IP addresses. In some such embodiments, the Programmable Network Device acts as a network of CPUs coupled by a high speed bus. The stack bus acts as a private LAN running at multi-gigabit rates. Thus the unique addresses used by the different CPUs 306-320 326 and the network processors 334 336 are all private addresses within the Programmable Network Device and are not sent over the public—i.e., non-management—interfaces.

In embodiments of the invention, communication within the Programmable Network Device is based on POSIX sockets, the API to which is available on every CPU. In embodiments of the Programmable Network Device, only the controller CPU 326 is directly coupled to the network interfaces of the Programmable Network Device. Internally, all processors can communicate with each other directly. In embodiments of the invention, by default, any process that communicates with external entities resides on the controller CPU 326, which has external interfaces and public IP addresses

The application CPUs 306-320 may run applications that communicate with networks external to the Programmable Network Device. Non-limiting examples of such applications include IPSEC, NAT, Firewall, etc. Moreover, such applications may be distributed across several application CPUs 306-320 for load sharing or redundancy purposes.

In embodiments of the invention, the private address assigned to the processors 306-320 326 334 336 are supplemented with virtual interfaces in every CPU corresponding to each external interface of the Programmable Network Device. The interface address is identical to the public address assigned to the external interface. When an application binds a ‘listening’ socket to a port and specifies the default IP address, the application will receive all packets addressed to this port, provided the CPU receives the packet. If an application is to receive packets from an external network coupled to the programmable network device 106, the application binds to the public IP addresses explicitly. In embodiments, an extended bind command may be used to facilitate this. In some such embodiments, the parameters for the extended bind command are identical to the standard bind command, and a protocol is used to register the bind parameters with the network processors 334 336. This protocol facilitates communication between the application performing the bind operation, and the Controller CPU 326. When a packet satisfying the specified bind parameters is received by the network processor 334 336, the network processor 334 336 places an appropriate MCCP MAC header 600 on the packet and forwards it to the CPU running the application.

While features described above enable the operation of common networking applications, embodiments of the invention also include additional techniques enabling applications to register for and redirect packets. Such techniques may be supported by calls which act as a high-level interface to the network processors 334 336. In embodiments, one such call allows applications to specify a mask that is used to redirect incoming packets to a particular CPU. Such calls may be employed by applications such as, by way of non-limiting example, IPSEC. In embodiments, another call may allow applications to specify a mask, a CPU, and a UDP destination port number. If an incoming packet matches this mask, the packet is encapsulated in a UDP packet with the specified destination port and sent to the specified CPU. By way of non-limiting example, such calls may be used by applications that serve as proxy servers or which perform content based filtering.

In some embodiments of the invention, each application may register a command line interface. The command line is accessible through any console interface, such as a serial console, modem, or a telnet session. Other suitable console interfaces shall be apparent to those skilled in the art.

H. Load Sharing between CPUs in the Programmable Network Device

The programmable network device environment provides applications with facilities to share load between different application CPUs 306-320. In embodiments, the application CPUs 306-320 are identical with respect to running applications, whether or not the CPU is on the main chassis, next to the network card, or in one of the stacked chassis. In some such embodiments, applications may be unaware of the CPU in which they are running.

In some embodiments, when multiple instances of an application share load, they communicate by use of higher-level protocols running over the Multi CPU Communication Protocol. The CPU manager may be used to determine the load on a particular CPU, and the resources (such as memory) available on a CPU.

In embodiments of the invention, if there are multiple instances of an application are registered with the name server for load sharing purposes using the same name, the name server, when queried, returns the addresses of each instance in round robin fashion. Other methods of returning addresses will be apparent to those skilled in the art. Thus, by way of an illustrative, non-limiting example, user sessions can be divided between multiple instances of an L2TP application.

In embodiments, the exact mechanism used for load sharing may differ for each type of application. For inherently stateless applications, each request can be directed independently, to a different application instance. For applications that maintain state for each request, subsequent requests belonging to the same session may be directed to the same instance of the application. In some embodiments, these decisions are made be the Forwarding Engine, which selects the appropriate CPU for a packet or flow.

Redundancy and Failover

Embodiments of the programmable network device include measures supporting recovery from software or hardware failures. For example, if a CPU or CPU card fails, the applications that were running on that CPU may be restarted on another CPU. The forwarding hardware 204 can continue forwarding data even if applications fail, to preserve communication between networks coupled via the programmable network device, and to continue existing sessions.

In embodiments, the programmable network device also offers additional facilities for supporting redundancy and failover. One service restarts applications that have failed by use of an application manager. Some transaction services (using manipulation of the packet.

Dynamically determined flows. Initially, such flows are processed completely in the application CPU 700, as no knowledge of the flow is contained in the forwarding engine 702 at the outset. The Forwarding Engine 702 is eventually configured by the application CPU 700 so that subsequent packets in the flow are handled entirely by the Forwarding Engine 702. As an example, the first packet in such flows is may comprise a SYN packet (for TCP connections) without the ACK bit set. An application such as NAT or Firewall processes the packet and forwards it to the eventual destination. When the response is received, a connection tracking mechanism 704 in the OS notes that the flow (or session) has been established, and invokes an API call 706 to transfer this flow to the forwarding engine 702. The API call in the forwarding engine 702 includes information enabling the forwarding engine 702 to forward packets for the session without involving the CPU. Eventually, when a session-ending packet (such as FIN) is received, it is sent to the application CPU 700, and the CPU invokes an API to remove the session from the forwarding engine 702.

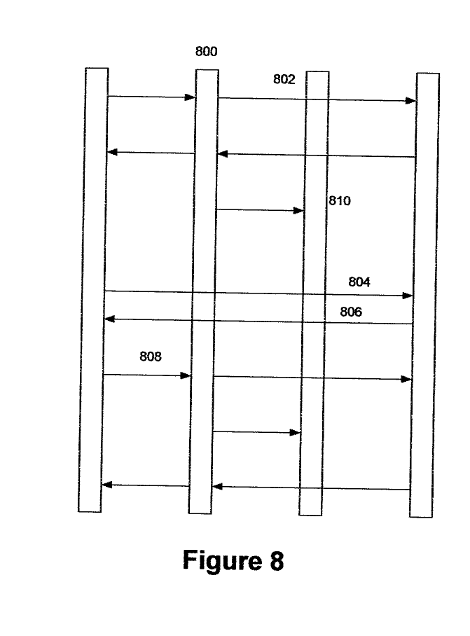

FIG. 8 illustrates a method of detecting a flow and altering the forwarding engine to the flow according to embodiments of the invention. The figure illustrates an example of a TCP flow set up and tear down. TCP control packets are sent to an application CPU 800 for processing. When a connection-tracking module sees the SYN packet and its response go by, it creates a new session context 810 identified by appropriate connection parameters, which may include one or more of the following: the source and destination IP address and the TCP source and destination ports. It invokes an API to the Network Processor interface on the Controller CPU to two-phase commit in some embodiments) may be supported. In embodiments, applications are executed in their own memory space in order to maintain isolation between applications and thereby increase reliability. Embodiments of the programmable network environment also offer support for hot-swapping cards in order to replace failed cards with functional ones.

Data Flow Within the Programmable Network Device

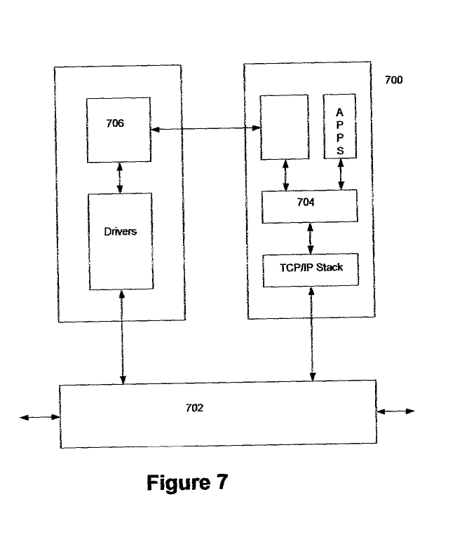

In embodiments of the invention, data flowing through the programmable network device may include one or more of the following types of traffic, which may processed according to an architecture illustrated in FIG. 7.

Statically determined flows. These may include the following types of flows:

Flows that are blocked at the input port, or dropped at the output port. In some embodiments, these flows may be inferred directly from firewall configuration.

Flows that are directed to particular CPUs. These may be determined statically or dynamically. For example, it may be known that an application is going to run on certain application CPUs 700 from the configuration. Alternatively, an application may make this known dynamically. In both of these cases, the traffic for that application is directed to the appropriate CPU from the input interface.

Flows passing through CPUs. These flows may be processed entirely by the application CPU 700, enabling the forwarding engine 702 to transmit the packet over an appropriate interface without further add a flow in either direction. Once the flow is set up, data packets (as show by the thick arrows) pass through the Forwarding Engine 804 806; in embodiments, these flows bypass the CPU. Finally, when a FIN packet passes through a CPU 808—in embodiments, control packets are always sent to a CPU—the flow is removed from the Forwarding Engine by invoking an API to the Network Processor interface on the Controller CPU. A similar paradigm can be used to detect UDP flows such as streaming traffic, or NFS traffic, as will be apparent to those skilled in the art.

I. Conclusion

The foregoing description is presented for illustrative purposes; many other equivalents and alternatives will be apparent to those skilled in the art.

1. A programmable network device, wherein the programmable network device couples a first computer network to a second computer network, the programmable network device comprising:
two or more software modules including
a first module, wherein the first module executes an application service on packets routed between the first network and the second network
a second module, wherein the second module executes a network management service on packets routed between the first network and the second network;
a real-time operating system, wherein the two or more software modules are executed on the real-time operating system;
wherein the programmable network device has a minimum throughput of 1 gigabit per second

2. The programmable network device of claim 2, wherein the application service is one of the group consisting of an MPLS protocol, an IP Sec protocol, an L2TP protocol, and a firewall.

3. The programmable network device of claim 3, wherein the network management service is one of the group consisting of an SLA function, an SNMP protocol, and a CMIP protocol.

4. The programmable network device of claim 3, wherein the network management service is a CORBA Object Request Broker.

5. The programmable network device of claim 3, wherein the network management service is an XML interpreter.

6. A method of loading a plurality of software modules onto a programmable network device, the programmable network device coupled to a LAN via a first interface and to an internetwork via a second interface, the method comprising:
sending a first module from the plurality of modules to the programmable network device via the internetwork;
loading the first module in the programmable network device;
executing the first module in the programmable network device, the first module performing a first network management function on the LAN;
sending a second module from the plurality of modules to the programmable network device via the internetwork;
loading the second module in programmable network device;
executing the second module in the programmable network device, the second module performing a second network management function on the LAN.

7. The method of claim 6, wherein the first function is one of the group consisting of an MPLS protocol, an IP Sec protocol, an L2TP protocol, and a firewall.

8. The method of claim 7, wherein the second function is one of the group consisting of an SLA function, an SNMP protocol, and a CMIP protocol.

9. The method of claim 7 wherein the second function is an XML interpreter.

10. The method of claim 7, wherein the second function is a CORBA Object Request Broker.

11. A programmable network device comprising:
a first network interface coupling the programmable network device to a Wide Area Network;
a second network device coupling the programmable network device to a Local Area Network;
a programmable packet forwarding engine in communication with the first network interface and the second network interface, wherein the programmable packet forwarding engine includes
one or more commands for filtering data packets sent between the LAN and the WAN via the programmable network device
a plurality of application CPUs for performing operations on the data packets sent between the LAN and the WAN;
an internal bus coupling the application CPUs to the programmable packet forwarding engine.

12. The programmable network device of claim 11, wherein the programmable packet forwarding engine includes a network processor.

13. The programmable network device of claim 12, wherein the network processor operates at a rate on or about 2.5 Gigabits per second.

14. The programmable network device of claim 11, wherein the network processor operates at a rate on or about 10 Gigabits per second.

15. The programmable network device of claim 14, wherein the network processor operates at a rate of 40 Gigabits per second.

16. The programmable network device of claim 11, wherein the internal bus operates at a rate on or about 10 Gigabits per second.

17. The programmable network device of claim 11, wherein the programmable network device forwards packets between the LAN and the WAN at rates on or about 1 Gigabit per second.

18. The programmable network device of claim 11 wherein the programmable network device forwards packets between the LAN and the WAN at rates on or about 4 Gigabits per second.

19. The programmable network device of claim 11, wherein the programmable network device forwards packets between the LAN and the WAN at rates on or about 16 Gigabits per second.

20. The programmable network device of claim 11, wherein the WAN is an internetwork.
